(19) United States
(12) Patent Application Publication
(10) Pub. No.: US 2002/0147990 A1
(43) Pub. Date: Oct. 10, 2002

(54) System and method for inserting video and audio packets into a video transport stream

(75) Inventors: Jin Lu, Croton-on-Hudson, NY (US); Kavitha V. Devara, Ossining, NY (US)

Correspondence Address: Jack E. Haken, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/829,786

(22) Filed: Apr. 10, 2001

(51) Int. Cl. H04N 7/16; H04N 7/10; H04N 5/445

(52) U.S. Cl. 725/135; 725/32; 725/36; 725/136; 725/39

(57) ABSTRACT

There is disclosed an apparatus for inserting new data packets into an incoming digital video transport stream containing a plurality of original data packets. The apparatus comprises: 1) an input buffer for storing the original data packets of the incoming digital video stream; and 2) a video processor that retrieves the stored original data packets from the input buffer and determines from the original data packets N data frequencies associated with N most recently received ones of the plurality of original data packets. The video processor estimates from the N data frequencies an estimated data frequency of a plurality of next incoming original data packets and uses the estimated data frequency to determine an insertion rate at which the new data packets may be inserted into the plurality of next incoming original data packets.

### TECHNICAL FIELD OF THE INVENTION

The present invention is directed, in general, to video broadcasting systems and, more specifically, to a system and method for inserting data packets into available spaces in a video transport stream.

### BACKGROUND OF THE INVENTION

Conventional television broadcast systems, including both wireless and cable systems, increasingly are being used to transmit data streams other than the basic television programs carried by the broadcast systems. For example, cable television systems now provide Internet access services to cable subscribers. The Internet data is carried in dedicated channels that are set aside for bidirectional Internet protocol (IP) traffic. Broadcast systems also transmit electronic program guide (EPG) data streams that contain information related to program titles, broadcast times, channel assignment, content summary, and the like. The television set or a set-top box (STB) allows a television viewer to review the EPG data on a selected channel by selecting a MENU or PROGRAM option on the remote control.

A digital broadcast transport stream contains video, audio, and data packets. Normally, there are spaces or null packets in the transport stream where additional data packets may be inserted. These additional data packets may include video clips, audio tracks, application programs, text files, and the like. It also is possible to insert additional data by replacing some of the data packets already in the transport stream. For example, a cable company may receive from a network video source a transport stream containing data packets for commercials, text, and EPG information. The cable system may replace the existing commercials and EPG data with replacement commercials and a new EPG for the local area. The gaps in the transport stream and the replaceable data packets in a transport stream constitute the available data bandwidth for insertion of new data packets.

The insertion can be done at various points of the delivery chain, for example, at local affiliates of a network. The inserted data packets can include local advertisements, web pages (perhaps tied to the original video stream), local weather reports, and the like. The inserted data formats include IP packets, MPEG packets. This capability of inserting data into a broadcast stream provides opportunities for service providers to provide new services to consumers.

The available data bandwidth for data insertion in the broadcast stream varies with time. A mechanism is needed to predict the available data bandwidth in the near future (e.g., next several seconds to half an hour) to use the available bandwidth efficiently. For example, suppose the data is streamed from a stock ticker web site at a configurable rate. If the streaming processor at the web site sends data at a rate higher than the available data bandwidth can accommodate, then some data from the stock ticker web site will be dropped. By estimating the available data bandwidth in a broadcast transport stream, the data insertion device can notify the streamer of the desired streaming data rate.

There is therefore a need in the art for improved broadcast systems disposed in downstream location capable of inserting new data packets into a digital transport stream. In particular, there is a need for video processing systems capable of more accurately estimating the available bandwidth for inserting new data packets in the next N seconds of a digital video transport stream.

### SUMMARY OF THE INVENTION

To address the above-discussed deficiencies of the prior art, it is a primary object of the present invention to provide, for use in a broadcast facility, an apparatus for inserting new data packets into an incoming digital video transport stream containing a plurality of original data packets. According to an advantageous embodiment of the present invention, the apparatus comprises: 1) an input buffer capable of storing the original data packets of the incoming digital video stream; and 2) a video processor capable of retrieving the stored original data packets from the input buffer and determining from the original data packets N data frequencies associated with N most recently received ones of the plurality of original data packets, wherein the video processor estimates from the N data frequencies an estimated data frequency of a plurality of next incoming original data packets and uses the estimated data frequency to determine an insertion rate at which the new data packets may be inserted into the plurality of next incoming original data packets.

According to one embodiment of the present invention, the video processor is further capable of identifying in the stored original data packets replaceable data packets not associated with at least one elementary data stream comprising a program carried in the incoming digital video transport stream.

According to another embodiment of the present invention, the video processor inserts the new data packets into the plurality of next incoming original data packets by replacing at least one replaceable data packet in the plurality of next incoming original data packets.

According to still another embodiment of the present invention, the video processor is further capable of identifying in the original data packets null data packets.

According to yet another embodiment of the present invention, the video processor inserts the new data packets into the plurality of next incoming original data packets by replacing at least one null data packet in the plurality of next incoming original data packets.

According to a further embodiment of the present invention, the video processor estimates the insertion rate as a function of a summation of the M most recently received original data packets.

According to a still further embodiment of the present invention, each of the M most recently received original data packets in the summation is scaled by a weighting factor, a(k).

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or, ” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary television broadcast system according to one embodiment of the present invention;

FIG. 2A illustrates an exemplary incoming digital data transport stream received at the local broadcast facility in FIG. 1 according to one embodiment of the present invention;

FIG. 2B illustrates an exemplary outgoing digital data transport stream transmitted from the local broadcast facility in FIG. 1 according to one embodiment of the present invention;

FIG. 3 illustrates in greater detail selected portions of the local broadcast facility according to one embodiment of the present invention; and

FIG. 4 is a flow diagram illustrating the data frequency estimation algorithm performed by the video processor in the local broadcast facility according to one embodiment of the present invention.

### DETAILED DESCRIPTION OF THE INVENTION

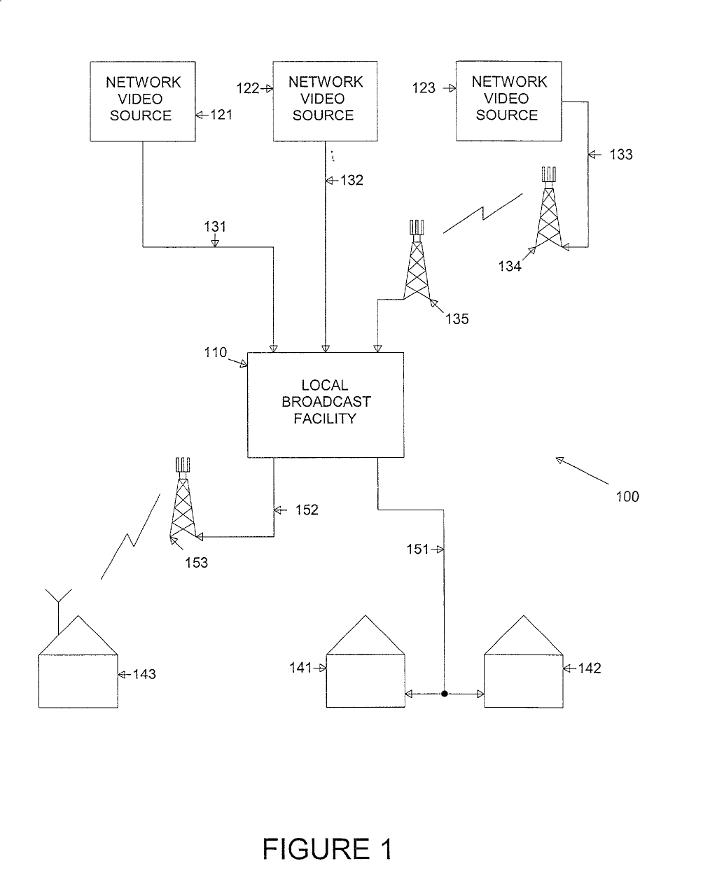

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged digital broadcast system.

FIG. 1 illustrates exemplary television broadcast system 100 according to one embodiment of the present invention. Television broadcast system 100 comprises local broadcast facility 110, which receives one or more digital video transport streams from each of network video sources 121-123. Local broadcast facility 110 may receive these digital video transport streams from wireline communication links or from wireless communication links. For example, local broadcast facility 110 receives one or more digital video transport streams from network video source 121 via wireline communication link 131 and receives one or more digital video transport streams from network video source 122 via wireline communication link 132.

Local broadcast facility 110 also comprises base transceiver stations 134 and 135, which wirelessly transmit one or more digital video transport streams from network video source 123 to local broadcast facility 110. In an exemplary embodiment, network video source 123 may transmit the digital video transport streams via communication line 133 to base transceiver station 134, which is part of a local multipoint distribution system (LMDS) network. In an LMDS network, a microwave link is used to transmit the digital video transport stream from base transceiver station 134 to base transceiver station 135.

Local broadcast facility 110 transmits the digital video transport streams to subscriber locations 141-143, which may include both private residences and business locations. If local broadcast facility 110 is part of a cable television system, local broadcast facility 110 may transmit one or more outbound digital video transport streams to subscriber locations 141 and 142 via communication wireline 151. Communication wireline 152 carries one or more outbound digital video transport streams from local broadcast facility 110 to transmitter 143, which wirelessly transmits the outbound digital video transport streams to subscriber location 143.

Each of the digital video transport streams received by and transmitted by local broadcast facility are carried in a 6 MHz broadcast channel. A transport stream usually contains several virtual channels, with each virtual channel containing a program. The program carried in a virtual channel is what a viewer sees on a signal television channel, such as a movie, a newscast, and a weather channel. Normally, each virtual channel is allocated a fixed bandwidth, such as 3 Megabits per second (Mbps).

The program in a virtual channel may contain several elementary streams, including a video stream, an audio stream, and a data stream. These elementary streams are digitally compressed. When the digitally compressed elementary streams carried in the virtual channel do not use up all of the allocated bandwidth, the remaining bandwidth may be filled with null packets in order to maintain a steady overall data throughput. However, at some points along the delivery chain, such as at local broadcast facility 110, useful data can be inserted into a virtual channel by replacing these null packets. Additionally, new data packets may be inserted by replacing existing data packets that belong to a replaceable elementary stream already in a virtual channel.

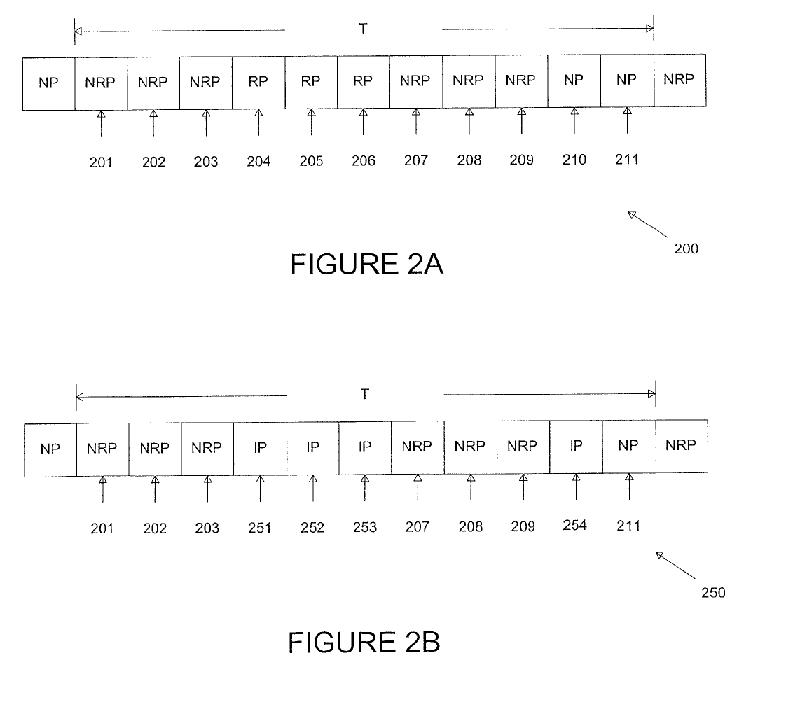

FIG. 2A illustrates exemplary incoming digital data transport stream 200 received at local broadcast facility 110 according to one embodiment of the present invention. Incoming digital data transport stream 200 comprises a plurality of non-replaceable packets, replaceable packets, null packets. By way of example, a non-replaceable packet (NRP) may be a data packet that is part of the elementary stream (e.g., audio or video) of the television program being viewed by a cable subscriber. Some of the non-replaceable (NRP) packets may include electronic program guide (EPG) data packets. A replaceable packet (RP) may be an additional audio, video, or text data packet that is not part of the television program being viewed by the cable subscriber and that had previously been inserted into the digital video transport stream at another network facility further upstream.

In the exemplary embodiment, an elementary time frame T of incoming digital data transport stream 200 having a duration of, for example, 100 milliseconds is shown. The time frame T of incoming digital data transport stream 200 comprises non-replaceable packets 201-203 and 207-209, replaceable packets 204-206, and null packets 210-211. It is assumed that the packets are moving in the broadcast chain at a constant speed. As is illustrated in FIG. 2A, the null packet clusters have a frequency of approximately 9% (2 out of 11 packets) and size of two packets, the replaceable packet clusters have a frequency of 27% (3 out of 11 packets) and size of 3 packets, and the non-replaceable packet clusters have a frequency of 27% (3 out of 11 packets) and size of 3 packets.

FIG. 2B illustrates exemplary outgoing digital data transport stream 250 transmitted from local broadcast facility 110 according to one embodiment of the present invention. Outgoing digital data transport stream 200 results from the replacement of some of the data packets in incoming digital data transport stream 200 by local broadcast facility 110. The exemplary time frame T of outgoing digital data transport stream 250 now comprises non-replaceable packets 201-203 and 207-209, inserted packets (IP) 251-254, and null packet 211. Inserted packets 251, 252, 253, and 254 have replaced replaceable packets 204, 205 and 206 and null packet 210, respectively. In an exemplary embodiment of the present invention, incoming digital data transport stream 200 and outgoing digital data transport stream 250 may be MPEG data transport streams and the non-replaceable packets and replaceable packets are basic MPEG data blocks.

The present invention introduces a simple way of estimating the available data bandwidth using statistics and electronic program guide (EPG) information. To predict the available data bandwidth (i.e., null packets plus replaceable data packets), the present invention predicts the frequency of the data packets of an elementary stream in a virtual channel. The data frequency (say, over a period of one second) of an elementary stream is, from a statistic point of view, a random number. However, due to the correlation of the scenes of a program and the encoding algorithms, the data frequency of the encoded program over one short period may be correlated to that over the next short period. This dependency makes it possible to predict the data frequency in the near future based on one or both of the current data frequency and the past data frequency.

The statistics of one program may be different from that of another. EPG information of a transport stream describes the program line-up of the virtual channels of a transport stream. It provides the schedule, program type, and a brief description of an upcoming program. The program type and brief description of a program (e.g., a baseball game, a news program, an action movie) may be used by the present invention to estimate how much data throughput is required for the program. For example, an action movie normally needs more data bandwidth than a newscast program. As a result, by analyzing the EPG information of a transport stream, the present invention may estimate or detect the following data stream events or parameters:

1) When the data frequency of a virtual channel may undergo a sharp change. Usually, sharp changes occur at the start and finish of a program and at the start and finish of a commercial; and

2) Typical (i.e., average) available data frequency of a program.

Combining a statistic method based on correlation of data frequencies and analysis of EPG information, the present invention comprises a data frequency estimation apparatus and method based on time series and filtering methods.

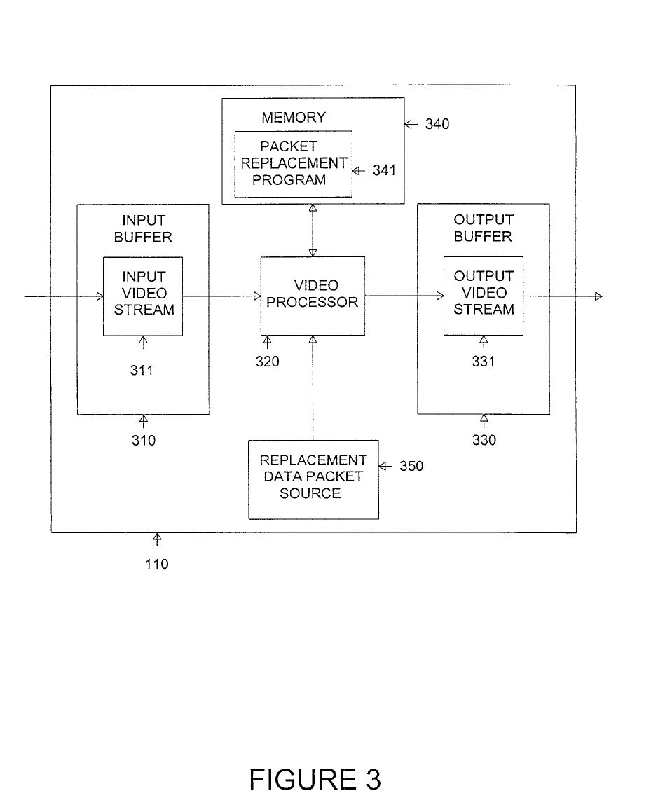

FIG. 3 illustrates in greater detail selected portions of local broadcast facility 110 according to one embodiment of the present invention. Local broadcast facility 110 comprises input buffer 310, video processor 320, output buffer 330, memory 340, and replacement data packet source 350. Memory 340 stores packet replacement program 341, which is executed by video processor 320. As will be explained below in greater detail, packet replacement program 341 contains, among other things, the code for the data frequency estimation algorithms used to insert new data packets into the available bandwidth in incoming digital video transport streams. According to an advantageous embodiment of the present invention, memory 340 may comprise a removable media drive, such as a CD-ROM drive and packet replacement program 341 may be a removable media disk that contains the code for the data frequency estimation algorithms.

Input buffer 310 receives an incoming digital video transport streams, such as exemplary incoming digital video transport stream 200, and stores the incoming digital video transport stream in input video stream block 311. Operating under the control of packet replacement program 341, video processor 320 retrieves each data packet in incoming video stream block 311 and determines whether each data packet is a non-replaceable packet (NRP), a replaceable packet (RP), nor a null packet (NP). According to an exemplary embodiment of the present invention, video processor 320 may identify the packet type of each data packet using MPEG header information associated with each data packet.

After video processor 320 identifies which data packets in incoming video stream block 311 are replaceable packets or null packets, video processor 320 replaces at least some of the original replaceable packets or null packets with inserted packets (IP) retrieved from replacement data packet source 350, thereby forming the outgoing digital video transport stream. Replacement data packet source 350 may comprise any know storage device, including a CD-ROM drive, and DVD drive, a VCR tape, or a network feed over which another incoming digital data transport stream is being received. Video processor 320 then stores the new outgoing digital video transport stream in output video stream block 331 in output buffer 330.

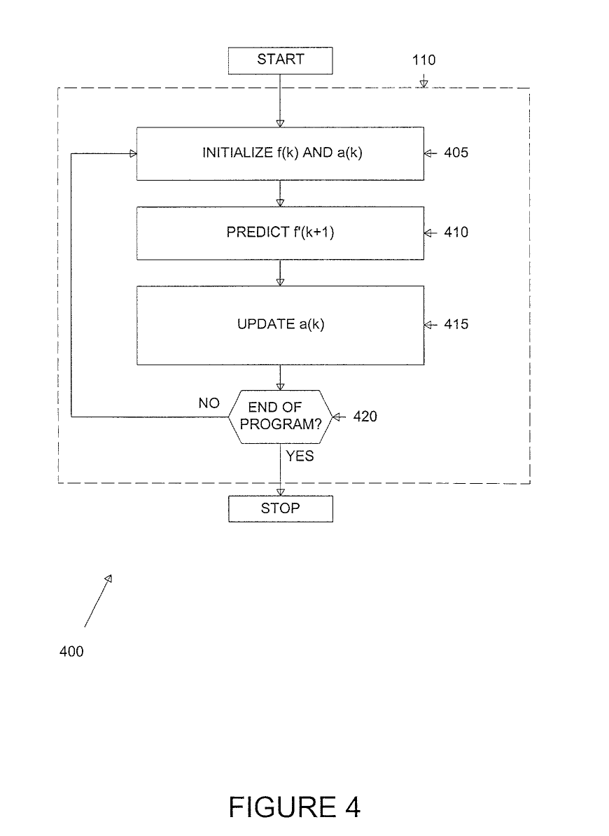

FIG. 4 depicts flow diagram 400, which illustrates the data frequency estimation algorithm performed by video processor 320 according to one embodiment of the present invention. Video processor 320 uses the frequency estimation algorithm to estimate (or predict) the data frequency of an elementary stream over the next period of S seconds (e.g., 100 msec. or 0.1 sec.). Initially, video processor 320 determines the program start time, t0, and finish time, t1, using, for example, the EPG information of the program. Video processor 320 also determines (or is given) the values a(k) for k=0, 1, . . . , m, where k is the index of a past period of N seconds, a(k) is a parameter (or weighting factor) associated with the k^{th} period, and m is the number of past and current periods used for prediction. According to an exemplary embodiment of the present invention, k, m, and a(k) may be chosen based on the program type (e.g., sports programs, newscast, action movie) as determined from the EPG information.

Under control of packet replacement program 341, video processor 320 executes the following Prediction Model algorithm to estimate the data frequency in the (k+1) period:

f′(k+1)=a(m)f(k)+a(m−1)f(k−1)+ . . . +a(0)f(k−m),

for k=N, N+1, N+2, . . .

The term f(k) is the data frequency of the replaceable and null packets in a program during the k^{th} time period. For example, if during a first selected time period 100 total data packets are received and among them, there are 10 null packets and 15 replaceable packets, then f(k)=25/100=0.25 for the first selected period.

The k^{th} time period is a period of n milliseconds (e.g., 100 msec.) during which the data frequency of the null and replaceable packets are measured or predicted. Here the number n, a constant, is selected by the data insertion system. Initially, f(k), f(k−1), f(k−2), . . . , f(k−m) may be set to zero. The Prediction Model is based on the assumption that future data frequency is correlated with past and current data frequency. Note that f′(k+1) is the estimate of f(k+1) using a prediction model and previous data frequencies f(k), f(k−1), f(k−2), so and so forth. The terms a(j) for j=0, 1, 2, . . . are the parameters of the exemplary Prediction Model. Note that f(k), for k=N, N+1, . . . on the right hand side of the equation are real measurements, not predictions.

The following algorithm is a reference algorithm for updating the Prediction Model and estimating f=(k+1). Other algorithms for updating the Prediction Model and calculating f=(k+1) also may be useful.

Initialize f(k) and a(k) (Process Step 405)—Video processor 320 measures the first N f(k) frequencies based on the real data, starting at time t0, the start of program. Video processor 320 tallies the number of replaceable and null packets against the total packets in the first N time periods. N is sufficiently large, usually larger than m, the number of parameters in the Prediction Model. Video processor 320 also initialize a(j) for j=0, 1, 2, . . . , m. These are typical parameters for a given type of program. The EPG information may be used to determine program type.

Prediction (Process Step 410)—At the end of period K, video processor 320 has measured f(k), k=K, K−1, K−2, . . . , where K is greater than or equal to N. Video processor 320 then uses the Prediction Model to predict f′(K+1), the data frequency for the next time period, based on the measured values of f(k) for k=K, K−1, K−2, . . . according to:

f′(K+1)=a(m)f(K)+a(m−1)f(K−1)+ . . . +a(0)f(K−m).

Update a(k) (Process Step 415)—As time proceeds, video processor 320 arrives at the end of time period K+1. Now, video processor 320 measures the real value of f(K+1). The difference between the real f(K+1) and the predicted f′(K+1) is a good measure of how accurate the Prediction Model is. Video processor 320 can use the difference to adjust the Prediction Model to make it more accurate in prediction. The following model is used to adjust the Prediction Model:

[f(k+1)−f′(k+1)]=a(m)f(k)+a(m−1)f(k−1)+ . . . +a(0)f(k−m),

for k=K, K−1, K−2, . . . , where a(j)=a_update(j)−a(j).

Video processor 320 solves the above equation for a(j) j=0, 1, 2, . . . , m. Video processor 320 then updates the Prediction Model with a(j)=a_update(j)=a(j)+a(j).

Loop (Process Step 420)—Video processor 320 then predicts the data frequency for the next time periods, K+2, K+3, . . . by repeating process steps 410 and 415 until the end of program is reached at time t1.

A filtering algorithm may be used to detect the spikes that usually result from sudden scene changes. These sudden scene changes can be part of the program or a commercial break. Various statistics techniques can be used to smooth out the effect of spikes so that the estimations are accurate. With regard to the initial values of a(j), I=0, . . . , m, if these values are known from previous estimations for other programs of the same type, the present invention may use them. Otherwise, they may be assumed to be zero initially.

Although the present invention has been described in detail, those skilled in the art should understand that they can make various changes, substitutions and alterations herein without departing from the spirit and scope of the invention in its broadest form.

What is claimed is:

1. For use in a broadcast facility, an apparatus for inserting new data packets into an incoming digital video transport stream containing a plurality of original data packets, said apparatus comprising:
an input buffer capable of storing said original data packets of said incoming digital video transport stream; and
a video processor capable of retrieving said stored original data packets from said input buffer and determining from said original data packets N data frequencies associated with N most recently received ones of said plurality of original data packets, wherein said video processor estimates from said N data frequencies an estimated data frequency of a plurality of next incoming original data packets and uses said estimated data frequency to determine an insertion rate at which said new data packets may be inserted into said plurality of next incoming original data packets.

2. The apparatus as set forth in claim 1 wherein said video processor is further capable of identifying in said stored original data packets replaceable data packets not associated with at least one elementary data stream comprising a program carried in said incoming digital video transport stream.

3. The apparatus as set forth in claim 2 wherein said video processor inserts said new data packets into said plurality of next incoming original data packets by replacing at least one replaceable data packet in said plurality of next incoming original data packets.

4. The apparatus as set forth in claim 1 wherein said video processor is further capable of identifying in said original data packets null data packets.

5. The apparatus as set forth in claim 4 wherein said video processor inserts said new data packets into said plurality of next incoming original data packets by replacing at least one null data packet in said plurality of next incoming original data packets.

6. The apparatus as set forth in claim 1 wherein said video processor estimates said insertion rate as a function of a summation of the M most recently received original data packets.

7. The apparatus as set forth in claim 6 wherein each of said M most recently received original data packets in said summation is scaled by a weighting factor, a(k).

8. A method for inserting new data packets into an incoming digital video transport stream containing a plurality of original data packets, the method comprising the steps of:
storing the original data packets of the incoming digital video stream;
retrieving the stored original data packets from the input buffer;
determining from the original data packets N data frequencies associated with N most recently received ones of the plurality of original data packets;
estimating from the N data frequencies an estimated data frequency of a plurality of next incoming original data packets; and
using the estimated data frequency to determine an insertion rate at which the new data packets may be inserted into the plurality of next incoming original data packets.

9. The method as set forth in claim 8 further comprising the step of identifying in the stored original data packets replaceable data packets not associated with at least one elementary data stream comprising a program carried in the incoming digital video transport stream.

10. The method as set forth in claim 9 further comprising the step of inserting the new data packets into the plurality of next incoming original data packets by replacing at least one replaceable data packet in the plurality of next incoming original data packets.

11. The method as set forth in claim 8 further comprising the step of identifying in the original data packets null data packets.

12. The method as set forth in claim 11 further comprising the step of inserting the new data packets into the plurality of next incoming original data packets by replacing at least one null data packet in the plurality of next incoming original data packets.

13. The method as set forth in claim 8 wherein the step of using the estimated data frequency to determine the insertion rate comprises the sub-step of estimating the insertion rate as a function of a summation of the M most recently received original data packets.

14. The method as set forth in claim 13 further comprising the sub-step of scaling each of the M most recently received original data packets in the summation by a weighting factor, a(k).

15. A television broadcasting system comprising:
a plurality of network video sources, each of said plurality of network video sources capable of transmitting at least one digital video transport stream to another facility in said television broadcast system; and
a plurality of broadcast facilities, each of said plurality of broadcast facilities comprising an apparatus for inserting new data packets into a received one of said at least one digital video transport stream containing a plurality of original data packets, said apparatus comprising:
an input buffer capable of storing said original data packets of said received digital video transport stream; and
a video processor capable of retrieving said stored original data packets from said input buffer and determining from said original data packets N data frequencies associated with N most recently received ones of said plurality of original data packets, wherein said video processor estimates from said N data frequencies an estimated data frequency of a plurality of next incoming original data packets and uses said estimated data frequency to determine an insertion rate at which said new data packets may be inserted into said plurality of next incoming original data packets.

16. The television broadcasting system as set forth in claim 15 wherein said video processor is further capable of identifying in said stored original data packets replaceable data packets not associated with at least one elementary data stream comprising a program carried in said received digital video transport stream.

17. The television broadcasting system as set forth in claim 16 wherein said video processor inserts said new data packets into said plurality of next incoming original data packets by replacing at least one replaceable data packet in said plurality of next incoming original data packets.

18. The television broadcasting system as set forth in claim 15 wherein said video processor is further capable of identifying in said original data packets null data packets.

19. The television broadcasting system as set forth in claim 18 wherein said video processor inserts said new data packets into said plurality of next incoming original data packets by replacing at least one null data packet in said plurality of next incoming original data packets.

20. The television broadcasting system as set forth in claim 15 wherein said video processor estimates said insertion rate as a function of a summation of the M most recently received original data packets.

21. The television broadcasting system as set forth in claim 20 wherein each of said M most recently received original data packets in said summation is scaled by a weighting factor, a(k).
